(19) United States
(12) Patent Application Publication
(10) Pub. No.: US 2016/0232672 A1
(43) Pub. Date: Aug. 11, 2016

(54) DETECTING MOTION REGIONS IN A SCENE USING AMBIENT-FLASH-AMBIENT IMAGES

(71) Applicant: QUALCOMM Incorporated, San Diego, CA (US)

(72) Inventor: Ramin Rezaiifar, Del Mar, CA (US)

(21) Appl. No.: 14/825,932

(22) Filed: Aug. 13, 2015

Related U.S. Application Data
(60) Provisional application No. 62/113,289, filed on Feb. 6, 2015.

(51) Int. Cl. G06T 7/00; G06T 11/60; H04N 5/235; G06T 7/20; H04N 5/225; H04N 5/232

(52) U.S. Cl. CPC G06T 7/0042; H04N 5/2256; H04N 5/23212; H04N 5/2353; G06T 7/20; G06T 11/60

(57) ABSTRACT

Systems and methods described herein can compensate for aberrations produced by a moving object in an image captured using a flash. In some embodiments, a method includes capturing a first image at time t−Δt₁, where Δt₁ represents the time difference between capturing the first image and capturing the second image, capturing the second image at a time t, the second image captured using a flash. The method also includes capturing a third image at a time t+Δt₂, where Δt₂ represents the time difference between capturing the second image and capturing the third image, determining motion information of an object that is depicted in the first, second and third image, and modifying at least one portion of the second image using the motion information and a portion of the first image, a portion of the third image, or a portion of the first image and a portion of the third image.

### RELATED APPLICATIONS

This application claims the benefit of U.S. Provisional Application No. 62/113,289 filed on Feb. 6, 2015, and entitled “DETECTING MOTION REGIONS IN A SCENE USING AMBIENT-FLASH-AMBIENT IMAGES,” which is incorporated by reference herein in its entirety.

### FIELD OF INVENTION

This invention generally relates to removing aberrations in an image that are caused by a moving object. More specifically, the inventions relates to using a sequence of images to determine regions in an image, generated using a flash light source, that depict the motion of an object, and removing such aberrations from the image.

### BACKGROUND

When capturing an image, a flash can be used to illuminate a scene with artificial light. The flash can illuminate the scene over such a short period of time that moving objects can appear stationary in a captured image. However, when using a flash, the background of a scene may appear darker than the foreground. In contrast, an image captured using only ambient light may provide a brighter depiction of the background than that produced in an image captured using a flash. By capturing both an ambient image and a flash image of a scene and fusing the images, an image can be generated having preferred features of each. However, motion of an object between the time at which the first image is captured and the time at which the second image is captured may cause the appearance of motion regions in the fused image.

Traditionally, motion in an image is detected by comparing a desired image with a reference image and determining a difference in the pixels between the images. Motion detection between images using flash and ambient lighting is challenging and often results in false-positives, which can be the result of shadows caused by a flash and/or having different visible areas in the flash and ambient images.

### SUMMARY OF THE INVENTION

One innovation is a method for compensating for aberrations produced by a moving object in an image. In some embodiments, the method includes generating a first image of a scene having a first exposure and a first external lighting, generating a second image of the scene having a second exposure and a second external lighting, the second exposure and the second external lighting being different from the first exposure and the first external lighting, the second image captured at a time subsequent to the first image, and generating a third image of the scene having the first exposure and the first external lighting, the third image captured at a time subsequent to the second image. The method may further include determining one or more motion regions using the first image and third image, the one or more motion regions indicating areas in one or more of the first image, second image, and third image that indicate the position of a moving object during the period of time over which the first image, second image, and third image are captured. Another innovation is a method for compensating for aberrations produced by a moving object in an image that was captured using a flash illumination system. In some embodiments, the method includes capturing a first image at a time t−Δt1, capturing a second image subsequent to the first image at a time t, said capturing the second image including activating the flash illumination system, where Δt1 represents the time between capturing the first image and capturing the second image, and capturing a third image subsequent to the second image at a time t+Δt2, where Δt2 represents the time between capturing the second image and capturing the third image. The method may further include determining motion information of an object that is depicted in the first, second and third image and modifying at least one portion of the second image using the motion information and a portion of the first image, a portion of the third image, or a portion of the first image and a portion of the third image.

In one example, the first image and the third image are captured using ambient light. The second image can be captured using a flash illumination system. The method can further include modifying one or more pixels of the first image and the third image, quantifying a difference value between each set of corresponding pixels, a set of corresponding pixels comprising a pixel in one of the first image or the third image and a pixel in the other of the first image or the third image corresponding to the same location in the image, and thresholding the difference values between each set of corresponding pixels. In one example, determining one or more motion regions is based at least in part on the location of each set of corresponding pixels having a difference value above a threshold value. In some embodiments, the method can further include generating a fourth image using one or more portions of the second image corresponding to motion regions in one or more of the first image and the third image and one or more portions of one or more of the first image and the third image. In some embodiments, the method further includes merging a portion of the second image with a portion of the first image, a portion of the third image, or a portion of the first image and a portion of the third image. In one example, merging a portion of the second image with a portion of the first image, a portion of the third image, or a portion of the first image and a portion of the third image includes layering one or more sections of one or more of the first image, second image, or third image, over a motion region detected in another one of the first image, second image, or third image, where the one or more sections comprise the same area of a scene as that concealed by a motion region from an image where the area was not concealed by a motion region.

Another aspect of the invention is computer readable medium having stored thereon instructions which when executed perform a method for compensating for aberrations produced by a moving object in an image.

Another aspect of the invention is an apparatus configured to compensate for aberrations produced by a moving object in an image. In some embodiments, the apparatus may include a flash system capable of producing illumination for imaging. In some embodiments, the apparatus may include a camera coupled to the flash system. The camera can be configured to generate a first image of a scene having a first exposure and a first external lighting, generate a second image of the scene having a second exposure and a second external lighting, the second exposure and the second external lighting being different from the first exposure and the first external lighting, the second image captured at a time subsequent to the first image, and generate a third image of the scene having the first exposure and the first external lighting, the third image captured at a time subsequent to the second image. The apparatus can also include a memory component configured to store images captured by the camera. In some embodiments, the apparatus can also include a processor configured to determine one or more motion regions using the first image and third image, the one or more motion regions indicating areas in one or more of the first image, second image, and third image that indicate the position of a moving object during the period of time over which the first image, second image, and third image are captured.

In one example, the first image and the third image are generated using ambient light and the second image is generated using a flash to illuminate the scene. In some embodiments, the processor is further configured to adjust auto white balance, auto exposure, and auto focusing parameters of the first image and the third image before determining the one or more motion regions. In some embodiments, the processor is further configured to modify one or more pixels of the first image and the third image, quantify a difference value between each set of corresponding pixels, a set of corresponding pixels comprising a pixel in one of the first image or the third image and a pixel in the other of the first image or the third image corresponding to the same location in the image, and threshold the difference values between each set of corresponding pixels. In some embodiments, the processor is configured to determine one or more motion regions based at least in part on the location of each set of corresponding pixels having a difference value above a threshold value. In some embodiments, the processor is further configured to generate a fourth image using one or more portions of the second image corresponding to motion regions in one or more of the first image and the third image and one or more portions of one or more of the first image and the third image. In some embodiments, the processor is further configured to merge a portion of the second image with a portion of the first image, a portion of the third image, or a portion of the first image and a portion of the third image. In some embodiments, the processor is configured to layer one or more sections of one or more of the first image, second image, or third image, over a motion region detected in another one of the first image, second image, or third image, where the one or more sections comprise the same area of a scene as that concealed by a motion region from an image where the area was not concealed by a motion region.

### BRIEF DESCRIPTION OF THE DRAWINGS

FIG. 1A depicts an example of a series of ambient-flash-ambient images in accordance with an illustrative embodiment.

FIG. 1B depicts an example of images that illustrate determining motion regions in a scene and a graphical illustration.

FIG. 1C depicts an example of a region indicative of the motion of an object between two ambient images in a series of ambient-flash-ambient images.

FIG. 2 depicts an example of a set of images that illustrate a merging of ambient and flash images in accordance with an illustrative embodiment.

FIG. 3 is a block diagram illustrating an example of an embodiment of an imaging device implementing some operative features.

FIG. 4 depicts a flowchart showing an example of an embodiment of a method of compensating for aberrations in an image.

FIG. 5 depicts a flowchart showing an example of an embodiment of a method of determining motion regions in a scene.

FIG. 6 depicts a flowchart showing another example of an embodiment of a method of compensating for aberrations in an image.

### DETAILED DESCRIPTION OF CERTAIN INVENTIVE ASPECTS

The following detailed description is directed to certain specific embodiments of the invention. However, the invention can be embodied in a multitude of different ways. It should be apparent that the aspects herein may be embodied in a wide variety of forms and that any specific structure, function, or both being disclosed herein is merely representative of one or more embodiments of the invention. An aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to, or other than one or more of the aspects set forth herein.

The examples, systems, and methods described herein are described with respect to digital camera technologies. The systems and methods described herein may be implemented on a variety of different digital camera devices. These include general purpose or special purpose digital camera systems, environments, or configurations. Examples of digital camera systems, environments, and configurations that may be suitable for use with the invention include, but are not limited to, digital cameras, hand-held or laptop devices, and mobile devices (e.g., phones, smart phones, Personal Data Assistants (PDAs), Ultra Mobile Personal Computers (UMPCs), and Mobile Internet Devices (MIDs)).

Embodiments may be used to correct motion aberrations in an image that includes a moving object. Embodiments may use a series of three images taken in quick succession, the first and third image having the same exposure and external lighting, to detect motion regions in a scene. Some embodiments use a series of ambient-flash-ambient images. “Ambient-flash-ambient” refers to a series of three images captured in a relatively short time frame, where the first and third images are captured using ambient light and the second image is captured using a flash. For example, a first image may be exposed using ambient light at a time t−Δt₁ where Δt₁ represents the time between the first image and the second image. A second image may be subsequently exposed at a time t, using a flash light source. A third image may be subsequently exposed using ambient light at a time t+Δt₂, where Δt₂ represents the time between the second image and the third image. In some embodiments, Δt₁ is equal to Δt₂. In some embodiments, Δt₁ is greater or less than Δt₂.

Portions of an image representative of one or more moving objects may be determined in the two ambient images that temporally surround the flash image (a first ambient image captured before the flash image and a second ambient image captured after the flash image). In some embodiments, one or more image parameters are set to be the same for capturing the ambient-lit images in a sequence of images captured using ambient light for the first image, a flash light source for the second image, and ambient light for the third image helps to detect motion of an object in the two ambient images. For example, in some embodiments, one or more of auto white balance, auto exposure, and auto focusing image parameters (collectively referred to herein as the “3A parameters”) may be set to the same or similar values for the two ambient images. Portions of two or more of the ambient-flash-ambient images may be fused to remove the appearance of so-called “ghost regions” or motion regions, that is, image aberrations in regions of an image caused by motion of an object.

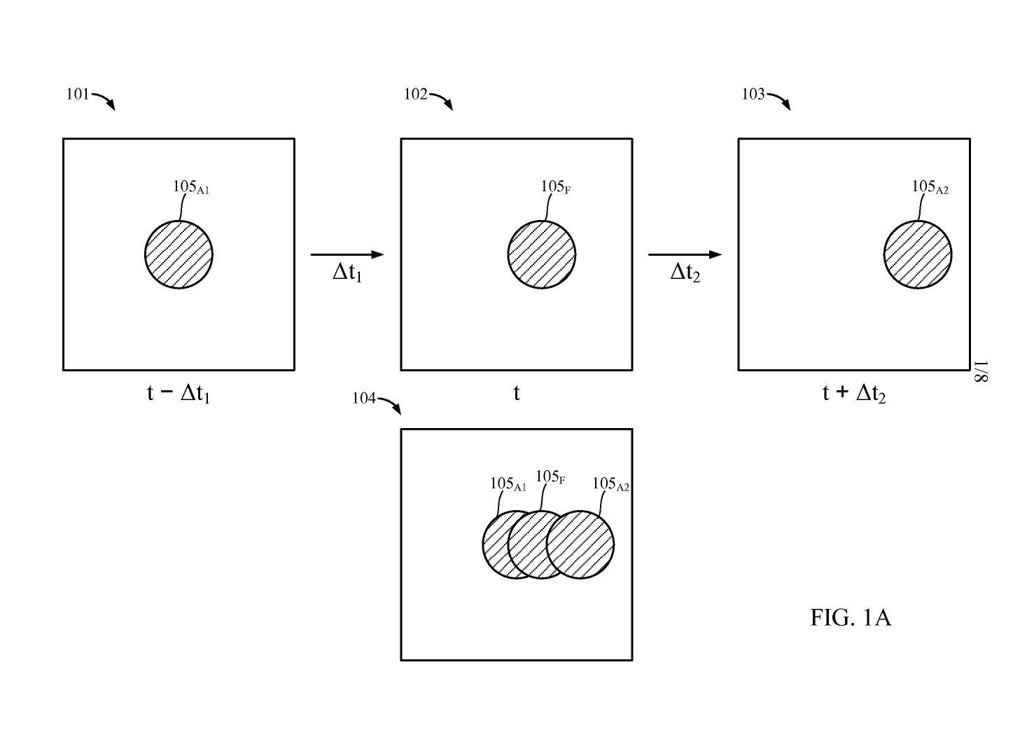

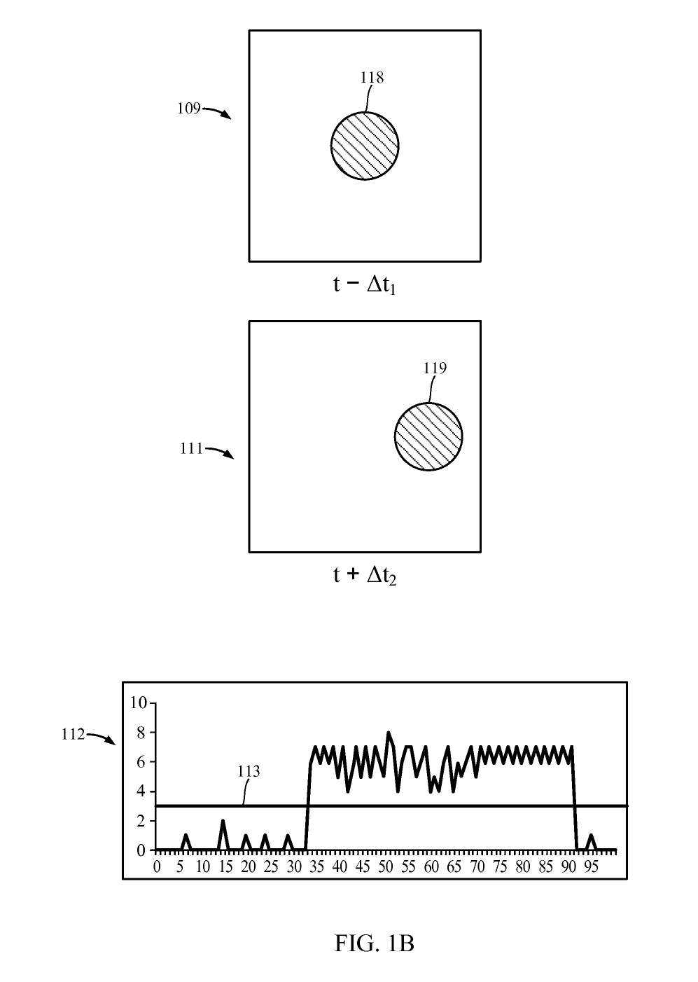

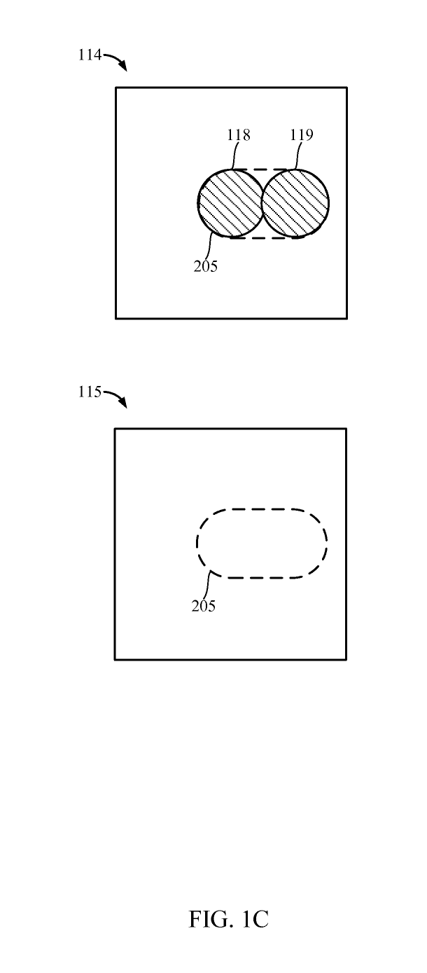

In an illustrative embodiment of methods and apparatuses relating to certain inventive aspects, three images are captured consecutively to detect motion regions in a scene and allow for compensation of those motion regions. Other embodiments may include only two images or more than three images. FIG. 1A illustrates an example of a series of three ambient-flash-ambient images 101, 102, and 103, respectively, captured consecutively by an imaging device (sometimes referred to herein as a “camera” for ease of reference), the images showing a moving object 105 in a scene. Image 101 was captured using ambient light at a time t−Δt₁. Image 101 shows the position of the object 105 at time t−Δt₁, depicted as region 105_{A1}. Image 102 was captured using a flash light source at time t. Δt₁ represents the period of time between the time at which image 101 was captured and the time at which the image 102 was captured. Image 102 shows the position of the object 105 at time t, depicted as region 105_{F}. Image 103 was captured using ambient light at a time t₊Δt₂. Δt₂ represents the period of time between the time at which image 102 was captured and the time at which the image 103 was captured. Image 103 shows the position of the object 105 at time t+Δt₂, depicted as region 105_{A2}.

Two or more images can be fused (or merged) to create a resulting image having features of each of the two or more images. In some embodiments, a flash image is fused with an ambient image so that one or more sections of the fused image will have features of the flash image and one or more sections of the fused image will have features of the ambient image. However, fusing two or more images capturing a moving object in a scene can result in several regions of the fused image that indicate the position of the moving object at different points in time. FIG. 1A illustrates an example of a fused ambient and flash image 104 generated by fusing images 101, 102, and 103. Image 104 shows regions 105_{A1}, 105_{F}, and 105_{A2}, depicting the position of the moving object 105 at times t−Δt₁, t, and t+Δt₂, respectively. These regions can be referred to as motion regions.

In some embodiments, an apparatus and a method may detect motion regions in the scene using information from the two ambient images in a series of ambient-flash-ambient images. FIG. 1B illustrates an example of images used to determine motion regions in a scene. Images 109 and 111 depict modified versions of images 101 and 103 (FIG. 1A), respectively, where images 101 and 103 have been processed to account for some innate differences, for example differences caused by slight movement of the camera or changes in ambient lighting, that could incorrectly be determined to indicate motion. Processing of the images can include blurring the images, converting the images to grayscale, morphological image opening, and morphological image closing. Region 118 of image 109 represents a processed region of image 101 corresponding to region 105_{A1}. Region 119 of image 111 represents a processed region of image 103 corresponding to region 105_{A2}. A value for each pixel, such as an intensity value, in one of the images 109 or 111 can be subtracted from a value for a corresponding pixel, a pixel corresponding to the same location in the image, in the other one of images 109 or 111 to quantify differences in the two images. A difference between a pair of corresponding pixels can indicate a region representative of a moving object. The absolute values of the differences can then be thresholded at a predefined value to further account for innate differences that could incorrectly be determined to indicate motion. Image 112 depicts a graph showing an example of data representing the absolute values of the differences between corresponding pixels in images 109 and 111. Each position on the x-axis represents a pair of corresponding pixels from images 109 and 111. The y-axis shows the absolute value for the difference between the pixels in each pair of corresponding pixels. Image 112 further shows a line 113 that represents a threshold value for the differences between corresponding pixels. Values above the threshold level are determined to indicate motion in the scene at the location of the corresponding pixels based on the comparison of image 109 and image 111.

The pixels determined to indicate motion can indicate the position of the moving object 105 at the time that image 101 was captured, t−Δt₁, and at the time that image 103 was captured, t+Δt₂, represented by regions 105_{A1} and 105_{A2} respectively in FIG. 1A. The position of the moving object 105 at times t−Δt₁ and t+Δt₂ can be used to estimate regions in which the moving object may have been present between times t−Δt₁ and t−Δt₂. FIG. 1C illustrates an example of an estimated region indicative of the motion of an object between two ambient images in a series of ambient-flash-ambient images. Images 114 and 115 depict a region 205 representative of the estimated positions of the object 105 between times t−Δt₁ and t+Δt₂ determined as described above with reference to FIG. 1B. Regions 118 and 119 are shown in image 114 for illustrative purposes. If two or more of the ambient-flash-ambient images are merged, region 205 represents the section of the scene in which motion regions may be present in the fused image.

In some embodiments, an apparatus and a method may merge (or fuse) image 101, image 102, and image 103 to generate an image having one or more portions from the flash image 102 and one or more portions of ambient image 101 and/or one or more portions of ambient image 103. A portion of the fused image corresponding to region 205, or part of region 205, can be taken from one of images 101, 102, and 103 so that the fused image depicts the position of the moving object 105 at a single one of times t−Δt₁, t, and t+Δt₂.

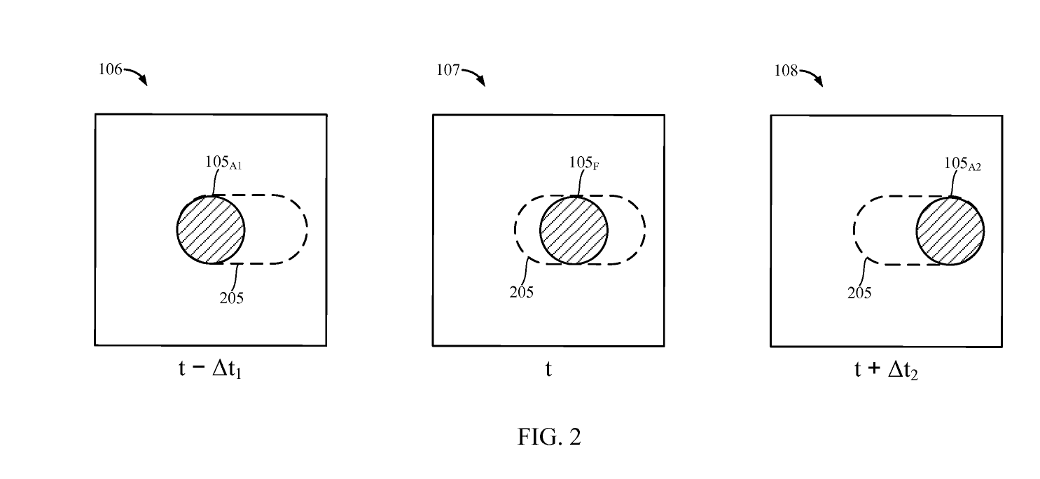

FIG. 2 depicts an example of a set of images, image 106, image 107, and image 108, each image illustrating combining a portion of image 101, image 102, and image 103 to form a resulting image that does not contain aberrations caused by the motion of the object 105, in accordance with some embodiments.

Image 106 depicts a fused image having portions of two or more of images 101, 102, and 103 (FIG. 1A), where the portion of the fused image corresponding to region 205 has been taken from image 101. Consequently, the image 106 depicts the position of the object 105 at time t−Δt₁, represented by region 105_{A1}, without aberrations in the motion regions representing the position of the object at the times at which images 102 and 103 were captured.

Image 107 depicts a fused image having portions of two or more of images 101, 102, and 103, where the portion of the fused image corresponding to region 205 has been taken from image 102. Consequently, the image 107 depicts the position of the object 105 at time t, represented by region 105_{F}, without aberrations in the motion regions representing the position of the object at the times at which images 101 and 103 were captured.

Image 108 depicts a fused image having portions of two or more of images 101, 102, and 103, where the portion of the fused image corresponding to region 205 has been taken from image 103. Consequently, the image 108 depicts the position of the object 105 at time t+Δt₂, represented by region 105_{A2}, without aberrations in the motion regions representing the position of the object at the times at which images 101 and 103 were captured.

In other implementations, the functionality described as being associated with the illustrated modules may be implemented in other modules, as one having ordinary skill in the art will appreciate.

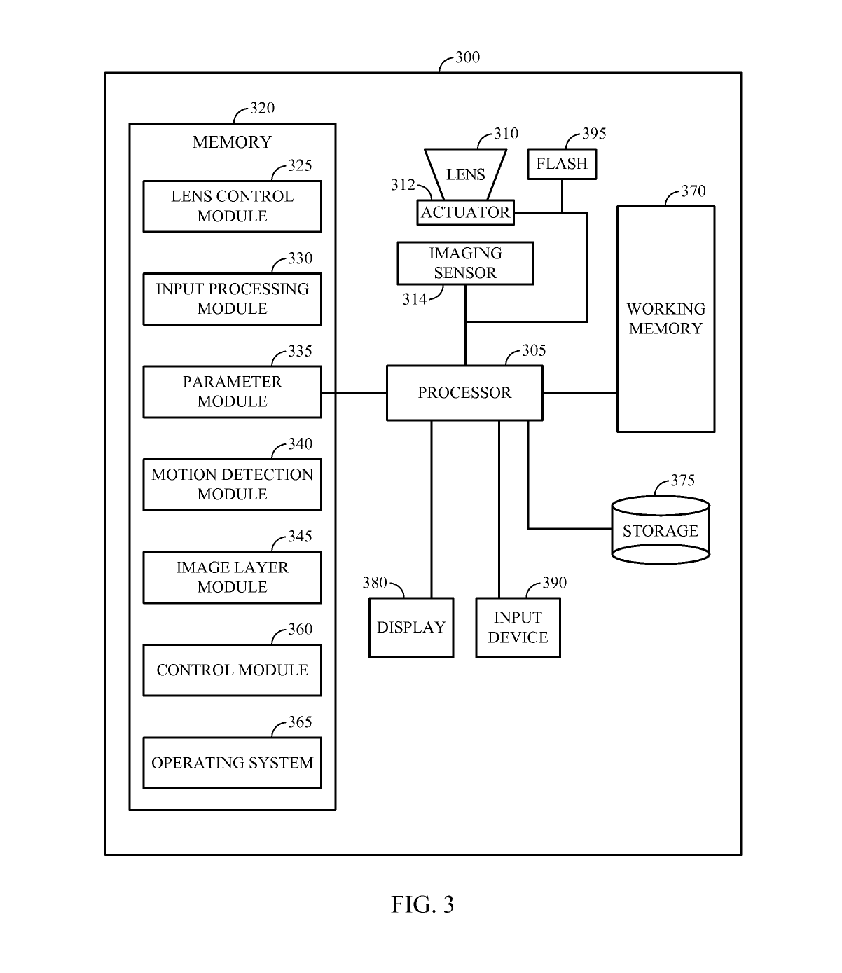

FIG. 3 is a block diagram illustrating an example of an imaging device that may be used to implement some embodiments. The imaging device 300 includes a processor 305 operatively connected to an imaging sensor 314, lens 310, actuator 312, working memory 370, storage 375, display 380, an input device 390, and a flash 395. In addition, processor 305 is connected to a memory 320. The illustrated memory 320 stores several modules that store data values defining instructions to configure processor 305 to perform functions of imaging device 300. The memory 320 includes a lens control module 325, an input processing module 330, a parameter module 335, a motion detection module 340, an image layer module 345, a control module 360, and an operating system 365.

In an illustrative embodiment, light enters the lens 310 and is focused on the imaging sensor 314. In some embodiments, the imaging sensor 314 can include a charge coupled device (CCD). In another aspect, the imaging sensor 314 can include a complimentary metal-oxide-semiconductor (CMOS) device. The lens 310 may be coupled to the actuator 312, and moved by the actuator 312. The actuator 312 is configured to move the lens 310 in a series of one or more lens movements during an AF operation. When the lens 310 reaches a boundary of its movement range, the lens 310 or actuator 312 may be referred to as saturated. The lens 310 may be actuated by any method known in the art including a voice coil motor (VCM), Micro-Electronic Mechanical System (MEMS), or a shape memory allow (SMA).

The display 380 is configured to display images captured via lens 310 and may also be utilized to implement configuration functions of device 300. In one implementation, display 380 can be configured to display one or more objects selected by a user, via an input device 390, of the imaging device.

The input device 390 may take on many forms depending on the implementation. In some implementations, the input device 390 may be integrated with the display 380 so as to form a touch screen display. In other implementations, the input device 390 may include separate keys or buttons on the imaging device 300. These keys or buttons may provide input for navigation of a menu that is displayed on the display 380. In other implementations, the input device 390 may be an input port. For example, the input device 390 may provide for operative coupling of another device to the imaging device 300. The imaging device 300 may then receive input from an attached keyboard or mouse via the input device 390.

Still referring to FIG. 3, a working memory 370 may be used by the processor 305 to store data dynamically created during operation of the imaging device 300. For example, instructions from any of the modules stored in the memory 320 (discussed below) may be stored in working memory 370 when executed by the processor 305. The working memory 370 may also store dynamic run time data, such as stack or heap data utilized by programs executing on processor 305. The working memory 375 may store data created by the imaging device 300. For example, images captured via lens 310 may be stored on storage 375.

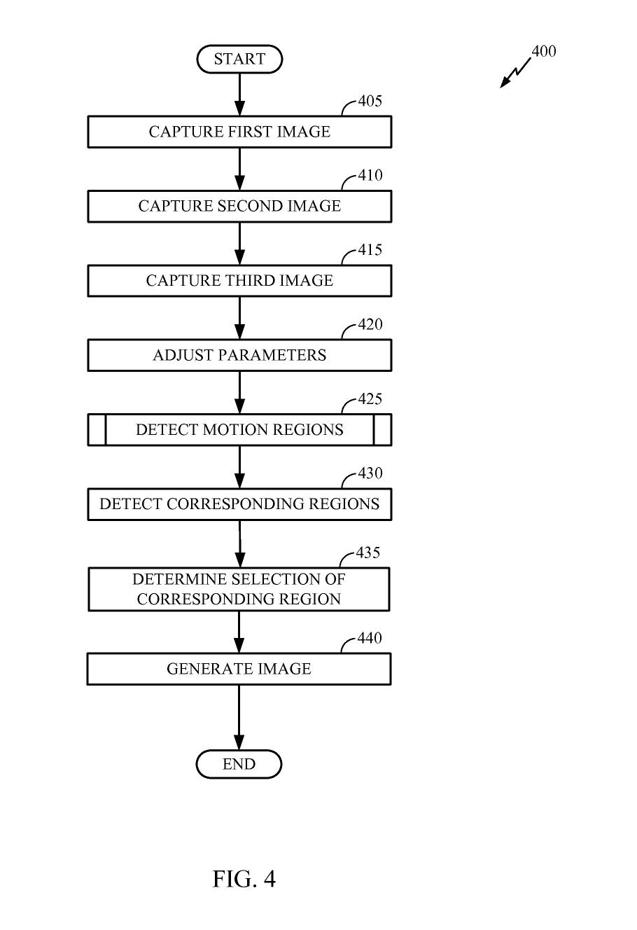

The memory 320 may be considered a computer readable media and stores several modules. The modules store data values defining instructions for processor 305. These instructions configure the processor 305 to perform functions of device 300. For example, in some aspects, memory 320 may be configured to store instructions that cause the processor 305 to perform one or more of methods 400, 425, and 600, or portions thereof, as described below and as illustrated in FIGS. 4-6. In the illustrated embodiment, the memory 320 includes a lens control module 325, an input processing module 330, a parameter module 335, a motion detection module 340, an image layering module 345, a control module 360, and an operating system 365.

The control module 360 may be configured to control the operations of one or more of the modules in memory 320. The operating system module 365 includes instructions that configure the processor 305 to manage the hardware and software resources of the device 300.

The lens control module 325 includes instructions that configure the processor 305 to control the lens 310. Instructions in the lens control module 325 may configure the processor 305 to effect a lens position for lens 310. In some aspects, instructions in the lens control module 325 may configure the processor 305 to control the lens 310, in conjunction with image sensor 314 to capture an image. Therefore, instructions in the lens control module 325 may represent one means for capturing an image with an image sensor 314 and lens 310.

Still referring to FIG. 3, in another aspect, the lens control module 325 can include instructions that configure the processor 305 to receive position information of lens 310, along with other input parameters. The lens position information may include a current and target lens position. Therefore, instructions in the lens control module 325 may be one means for generating input parameters defining a lens position. In some aspects, instructions in the lens control module 325 may represent one means for determining current and/or target lens position.

The input processing module 330 includes instructions that configure the processor 305 to read input data from the input device 390. In one aspect, input processing module 330 may configure the processor 305 to detect objects within an image captured by the image sensor 314. In another aspect, input processing module 330 may configure processor 305 to receive a user input from input device 390 and identify a user selection or configuration based on the user manipulation of input device 390. Therefore, instructions in the input processing module 330 may represent one means for identifying or selecting one or more objects within an image.

The parameter module 335 includes instructions that configure the processor 305 to determine the auto white balance, the auto exposure, and the auto focusing parameters of an image captured by the imaging device 300. The parameter module 335 may also include instructions that configure the processor 305 to adjust the auto white balance, auto exposure, and auto focusing parameters of one or more images.

The motion detection module 340 includes instructions that configure the processor 305 to detect a section of an image that may indicate motion of an object. In some embodiments, the motion detection module 340 includes instructions that configure the processor to compare sections of two or more images to detect sections of the images that may indicate motion of an object. The processor can compare sections of the two or more images by quantifying differences between pixels in the two or more images. In some embodiments, the motion detection module 340 includes instructions that configure the processor to threshold the values determined by quantifying the differences between pixels in the two or more images. In some embodiments, the two or more images are two ambient images in a series of ambient-flash-ambient images. The motion detection module 340 can also include instructions that configure the processor to modify the two or more images prior to comparison to account for innate differences in the images that could be mistakenly identified as motion regions.

The image layering module 345 includes instructions that configure the processor 305 to detect a section of an image that may be used to add to or modify another image. The image layering module 345 may also include instructions that configure the processor 305 to layer a section of an image on top of another image. In an illustrative embodiment, the image layering module 345 may include instructions for detecting sections of an image corresponding to a motion region in another image. The image layering module 345 may further include instructions to use a section of an image to add to or modify a section of another image corresponding to an aberration in a motion region. The image layering module 345 may also include instructions to layer a section of an image on to a section of another image.

FIG. 4 depicts a flowchart of an example of an embodiment of a process 400 for compensating for aberrations produced by a moving object in a series of images. The process 400 begins at block 405, where a first image, such as image 101 depicted in FIG. 1A, is captured by an imaging device, such as imaging device 300 depicted in FIG. 3, at a time t−Δt₁. The first image can be captured using ambient light. Δt₁ represents the period of time between when the imaging device captures the first image and when the imaging device captures a second image.

After capturing the first image, the process 400 moves to block 410, where a second image, for example image 102 depicted in FIG. 1A, is captured by the imaging device at a time t. The second image can be captured using a flash that illuminates the scene.

After capturing the second image, the process 400 moves to block 415, where a third image, for example image 103 as depicted in FIG. 1A, is captured by the imaging device at a time t+Δt₂. Δt₂ represents the period of time between when the imaging device captures the second image and when the imaging device captures the third image. The third image can be captured using ambient light.

After capturing the third image, the process 400 moves to block 420, where the auto white balance, auto exposure, and auto focusing parameters of the first image and the third image may be adjusted to the same or similar values.

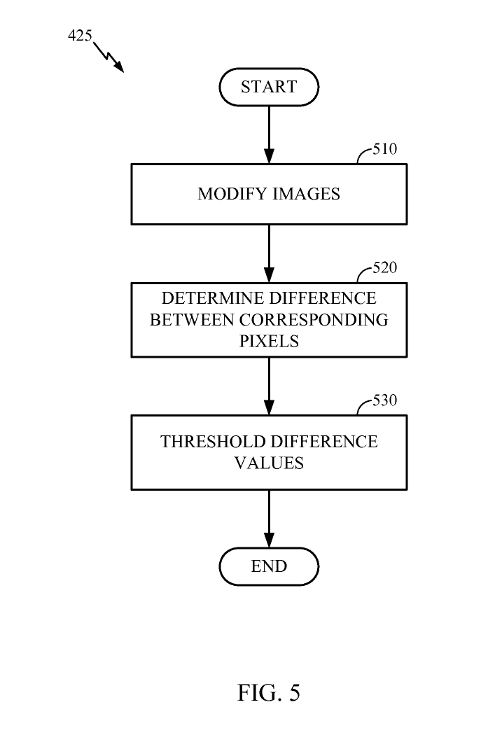

The process 400 then moves to process block 425, where motion regions are detected. An embodiment of detecting motion regions is described below with respect to FIG. 5.

After motion regions are detected, the process moves to block 430, where one or more portions of the first image, of the second image, and of the third image that correspond to a region indicative of an object in motion in the scene, such as region 205 depicted in FIGS. 1C and 2, are determined.

The process 400 then moves to block 435, where a determination is made of a selection of a corresponding region from one of the first image, the second image, and the third image.

After a selection of a corresponding region from one of the first image, the second image, and the third image is determined, the process moves to block 440 where an image is generated having portions from two or more of the first image, second image, and third image, where one of the portions is the determined corresponding region. Consequently, the image is generated without motion regions. The process then concludes.

FIG. 5 depicts a flowchart illustrating an example of an embodiment of a process 425 for determining motion regions between two images in a series of ambient-flash-ambient images (for example, images 101, 102, and 103 depicted in FIG. 1). In some embodiments, only the ambient images 101 and 103 are used for motion detection. The process 425 begins at block 510, where one or more of the ambient-flash-ambient images are modified to account for innate differences, such as differences caused by slight movement of the camera or changes in ambient lighting, for example, that could incorrectly be determined to indicate motion. For example, the images can be modified (if needed) by blurring the images, converting the images to grayscale, through morphological image opening, through morphological image closing, or any other suitable image processing techniques.

After the images are modified, the process moves to block 520, where differences are determined between pixels corresponding to the same location in two images of the modified images. The difference can be determined by subtracting a value for each pixel, such as an intensity value, from one of the modified images from a value for a corresponding pixel in the other modified image. Non-zero difference values indicate a difference exists in the corresponding pixels of the two images that are being compared, which can indicate that an object may have been moving in the region of the image shown in the pixel during the time period between the two images.

After difference values between corresponding pixels are determined, the process 425 moves to block 530, where the absolute value of each difference value is thresholded. The absolute value of each difference value can be thresholded to account for innate differences that could incorrectly be determined to indicate motion. Values above a threshold level can be determined to indicate motion in the scene captured in the series of ambient-flash-ambient images. The threshold level can be a preset value determined by experimentation. The threshold level may be determined empirically to minimize false motion determinations while identifying as much motion as possible. In some embodiments, the threshold level can be dynamically set by a user. Alternatively, the threshold level can be semi-automatically set based on a user input and processing results. After the absolute value of each difference value is thresholded, the process 425 concludes.

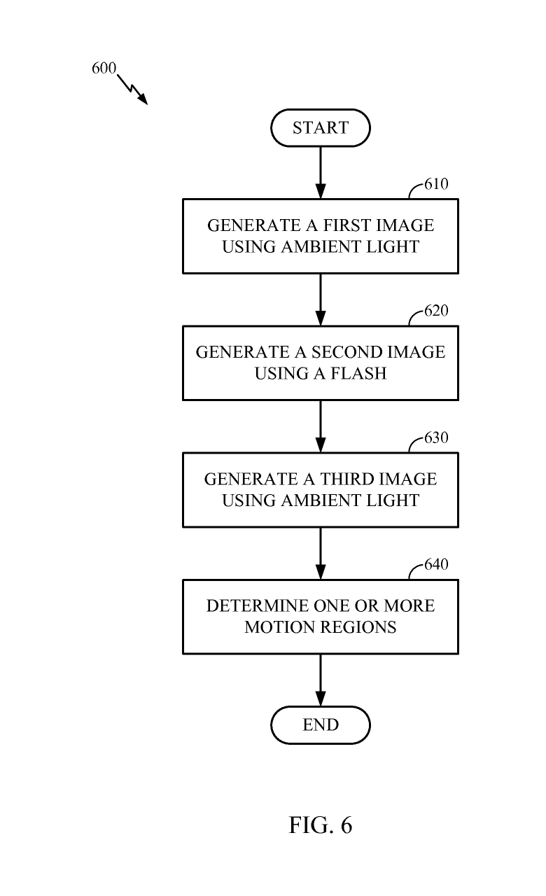

FIG. 6 depicts a flowchart illustrating an example of an embodiment of a process 400 of compensating for aberrations produced by a moving object in an image that was captured using a flash light source to illuminate at least one object in the image. The process 600 beings at a step 610 where a first image of a scene (for example image 101 depicted in FIG. 1A) is generated using ambient light. The first image can capture the scene at a time t−Δt₁, where Δt₁ represents a period of time between the first image and a second image.

After the first image is generated using ambient light, the process moves to a step 620, where a second image of the scene (for example, image 102 depicted in FIG. 1A) is generated using a flash to illuminate the scene, the second image being captured subsequent to capturing the first image. The second image can capture the scene at a time t.

After the second image is generated using a flash to illuminate the scene, the process 600 moves to step 630, where a third image of the scene (for example, image 103 depicted in FIG. 1A) is generated using ambient light, the third image being captured subsequent to capturing the second image. The third image can capture the scene at a time t+Δt₂, where Δt₂ represents a period of time between the second image and the third image.

After the third image of the scene is captured, the process moves to block 640, where one or more motion regions are determined. Determining motion regions can include determining a difference in characteristics of corresponding pixels that are in the first image and the third image. Such differences can be, for example, an intensity difference or a color difference. Embodiments of determining one or more motion regions are explained above with reference to FIGS. 1B and 5. After the motion regions are determined, the process concludes.

Implementations disclosed herein provide systems, methods and apparatus for multiple aperture array cameras free from parallax and tilt artifacts. One skilled in the art will recognize that these embodiments may be implemented in hardware, software, firmware, or any combination thereof.

In some embodiments, the circuits, processes, and systems discussed above may be implemented in a wireless communication device. The wireless communication device may be a kind of electronic device used to wirelessly communicate with other electronic devices. Examples of wireless communication devices include cellular telephones, smart phones, Personal Digital Assistants (PDAs), e-readers, gaming systems, music players, netbooks, wireless modems, laptop computers, tablet devices, etc.

The wireless communication device may include one or more image sensors, two or more image signal processors, and a memory including instructions or modules for carrying out the processes discussed above. The device may also have data, a processor loading instructions and/or data from memory, one or more communication interfaces, one or more input devices, one or more output devices such as a display device and a power source/interface. The wireless communication device may additionally include a transmitter and a receiver. The transmitter and receiver may be jointly referred to as a transceiver. The transceiver may be coupled to one or more antennas for transmitting and/or receiving wireless signals.

The wireless communication device may wirelessly connect to another electronic device (e.g., base station). A wireless communication device may alternatively be referred to as a mobile device, a mobile station, a subscriber station, a user equipment (UE), a remote station, an access terminal, a mobile terminal, a terminal, a user terminal, a subscriber unit, etc. Examples of wireless communication devices include laptop or desktop computers, cellular phones, smart phones, wireless modems, e-readers, tablet devices, gaming systems, etc. Wireless communication devices may operate in accordance with one or more industry standards such as the 3rd Generation Partnership Project (3GPP). Thus, the general term “wireless communication device” may include wireless communication devices described with varying nomenclatures according to industry standards (e.g., access terminal, user equipment (UE), remote terminal, etc.).

The functions described herein may be stored as one or more instructions on a processor-readable or computer-readable medium. The term “computer-readable medium” refers to any available medium that can be accessed by a computer or processor. By way of example, and not limitation, such a medium may include RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The methods disclosed herein include one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

In the foregoing description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

Headings are included herein for reference and to aid in locating various sections. These headings are not intended to limit the scope of the concepts described with respect thereto. Such concepts may have applicability throughout the entire specification.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

What is claimed is:

1. A method for compensating for aberrations produced by a moving object in an image comprising:
generating a first image of a scene having a first exposure and a first external lighting;
generating a second image of the scene having a second exposure and a second external lighting, the second exposure and the second external lighting being different from the first exposure and the first external lighting, the second image captured at a time subsequent to the first image;
generating a third image of the scene having the first exposure and the first external lighting, the third image captured at a time subsequent to the second image; and
determining one or more motion regions using the first image and third image, the one or more motion regions indicating areas in one or more of the first image, second image, and third image that indicate a position of a moving object during the period of time over which the first image, second image, and third image are captured.

2. The method of claim 1, wherein the first image and the third image are generated using ambient light and the second image is generated using a flash to illuminate the scene.

3. The method of claim 1, further comprising adjusting auto white balance, auto exposure, and auto focusing parameters of the first and third image to the same values before determining the one or more motion regions.

4. The method of claim 1, wherein the determining one or more motion regions comprises:
modifying one or more pixels of the first image and the third image;
quantifying a difference value between each set of corresponding pixels, a set of corresponding pixels comprising a pixel in one of the first image or the third image and a pixel in the other of the first image or the third image corresponding to the same location in the image; and
thresholding the difference values between each set of corresponding pixels.

5. The method of claim 1, wherein the determining one or more motion regions is based at least in part on the location of each set of corresponding pixels having a difference value above a threshold value.

6. The method of claim 1, further comprising generating a fourth image using one or more portions of the second image corresponding to motion regions in one or more of the first image and the third image and one or more portions of one or more of the first image and the third image.

7. The method of claim 1, further comprising merging a portion of the second image with a portion of the first image,
a portion of the third image, or
a portion of the first image and a portion of the third image.

8. The method of claim 7, wherein
merging a portion of the second image with a portion of the first image,
a portion of the third image, or
a portion of the first image and a portion of the third image,
comprises layering one or more sections of one or more of the first image, the second image, or the third image, over a motion region detected in another one of the first image, second image, or third image, wherein the one or more sections comprise the same area of a scene as that concealed by a motion region from an image where the area was not concealed by a motion region.

9. A non-transitory computer readable storage medium storing instructions that, when executed, cause at least one physical computer processor to perform a method of adjusting the position of a touch input, the method comprising:
generating a first image of a scene having a first exposure and a first external lighting;
generating a second image of the scene having a second exposure and a second external lighting, the second exposure and the second external lighting being different from the first exposure and the first external lighting, the second image captured at a time subsequent to the first image;
generating a third image of the scene having the first exposure and the first external lighting, the third image captured at a time subsequent to the second image; and
determining one or more motion regions using the first image and third image, the one or more motion regions indicating areas in one or more of the first image, second image, and third image that indicate the position of a moving object during the period of time over which the first image, second image, and third image are captured.

10. The non-transitory computer readable storage medium of claim 9, wherein the first image and the third image are generated using ambient light and the second image is generated using a flash to illuminate the scene.

11. The non-transitory computer readable storage medium of claim 9, wherein the method further comprises adjusting the auto white balance, auto exposure, and auto focusing parameters of the first and third image to the same values before determining the one or more motion regions.

12. The non-transitory computer readable storage medium of claim 9, wherein the method comprises:
modifying one or more pixels of the first image and the third image;
quantifying a difference value between each set of corresponding pixels, a set of corresponding pixels comprising a pixel in one of the first image or the third image and a pixel in the other of the first image or the third image corresponding to the same location in the image; and
thresholding the difference values between each set of corresponding pixels.

13. The non-transitory computer readable storage medium of claim 12, wherein the determining one or more motion regions is based at least in part on the location of each set of corresponding pixels having a difference value above a threshold value.

14. The non-transitory computer readable storage medium of claim 9, wherein the method further comprises, generating a fourth image using one or more portions of the second image corresponding to motion regions in one or more of the first image and the third image and one or more portions of one or more of the first image and the third image.

15. The non-transitory computer readable storage medium of claim 9, wherein the method further comprises merging a portion of the second image with a portion of the first image,
a portion of the third image, or
a portion of the first image and a portion of the third image.

16. The non-transitory computer readable storage medium of claim 15, wherein merging a portion of the second image with a portion of the first image,
a portion of the third image, or
a portion of the first image and a portion of the third image.
comprises layering one or more sections of one or more of the first image, second image, or third image, over a motion region detected in another one of the first image, second image, or third image, wherein the one or more sections comprise the same area of a scene as that concealed by a motion region from an image where the area was not concealed by a motion region.

17. An apparatus configured to compensate for aberrations produced by a moving object in an image, comprising:
a flash system capable of producing illumination for imaging;
a camera coupled to the flash system, wherein the camera is configured to:
generate a first image of a scene having a first exposure and a first external lighting;
generate a second image of the scene having a second exposure and a second external lighting, the second exposure and the second external lighting being different from the first exposure and the first external lighting, the second image captured at a time subsequent to the first image;
generate a third image of the scene having the first exposure and the first external lighting, the third image captured at a time subsequent to the second image;
a memory component configured to store images captured by the camera; and
a processor configured to determine one or more motion regions using the first image and third image, the one or more motion regions indicating areas in one or more of the first image, second image, and third image that indicate the position of a moving object during the period of time over which the first image, second image, and third image are captured.

18. The apparatus of claim 17, wherein the first image and the third image are generated using ambient light and the second image is generated using a flash to illuminate the scene.

19. The apparatus of claim 17, wherein the processor is further configured to adjust auto white balance, auto exposure, and auto focusing parameters of the first image and the third image before determining the one or more motion regions.

20. The apparatus of claim 17, wherein the processor is configured to:
modify one or more pixels of the first image and the third image;
quantify a difference value between each set of corresponding pixels, a set of corresponding pixels comprising a pixel in one of the first image or the third image and a pixel in the other of the first image or the third image corresponding to the same location in the image; and
threshold the difference values between each set of corresponding pixels.

21. The apparatus of claim 20, wherein the processor is configured to determine one or more motion regions based at least in part on the location of each set of corresponding pixels having a difference value above a threshold value.

22. The apparatus of claim 17, wherein the processor is further configured to generate a fourth image using one or more portions of the second image corresponding to motion regions in one or more of the first image and the third image and one or more portions of one or more of the first image and the third image.

23. The apparatus of claim 17, wherein the processor is further configured to merge a portion of the second image with a portion of the first image,
a portion of the third image, or
a portion of the first image and a portion of the third image.

24. The apparatus of claim 23, wherein the processor is configured to layer one or more sections of one or more of the first image, second image, or third image, over a motion region detected in another one of the first image, second image, or third image, wherein the one or more sections comprise the same area of a scene as that concealed by a motion region from an image where the area was not concealed by a motion region.

25. A method for compensating for aberrations produced by a moving object in an image that was captured using a flash illumination system, the method comprising:
capturing a first image at a time t−Δt₁;
capturing a second image subsequent to the first image at a time t, said capturing the second image including activating the flash illumination system, wherein Δt₁ represents the time between capturing the first image and capturing the second image;
capturing a third image subsequent to the second image at a time t+Δt₂, wherein Δt₂ represents the time between capturing the second image and capturing the third image;
determining motion information of an object that is depicted in the first, second and third image; and
modifying at least one portion of the second image using the motion information and a portion of the first image, a portion of the third image, or a portion of the first image and a portion of the third image.

26. The method of claim 25, wherein the first image and the third image are captured using the same exposure and the same external lighting.

27. The method of claim 25, further comprising adjusting the auto white balance, auto exposure, and auto focusing parameters of the first and third image before determining the motion information.

28. The method of claim 25, wherein the determining motion information comprises:
modifying one or more pixels of the first image and the third image;
quantifying a difference value between each set of corresponding pixels, a set of corresponding pixels comprising a pixel in one of the first image or the third image and a pixel in the other of the first image or the third image corresponding to the same location in the image; and
thresholding the difference values between each set of corresponding pixels.

29. The method of claim 25, wherein modifying at least one portion of the second image comprises merging a portion of the second image with a portion of the first image,
a portion of the third image, or
a portion of the first image and a portion of the third image.

30. The method of claim 25, wherein merging a portion of the second image with a portion of the first image,
a portion of the third image,
or a portion of the first image and a portion of the third image,
comprises layering one or more sections of one or more of the first image, second image, or third image, over a motion region detected in another one of the first image, second image, or third image, wherein the one or more sections comprise the same area of a scene as that concealed by a motion region from an image where the area was not concealed by a motion region.
